(19) United States
(12) Patent Application Publication
(10) Pub. No.: US 2020/0317017 A1
(43) Pub. Date: Oct. 8, 2020

(54) VEHICLE CONTROLLER

(71) Applicant: AISIN SEIKI KABUSHIKI KAISHA, Kariya-shi (JP)

(72) Inventors: Masashi NOBUTOKI, Kariya-shi (JP); Shintaro SUZUKI, Kariya-shi (JP)

(73) Assignee: AISIN SEIKI KABUSHIKI KAISHA, Kariya-shi (JP)

(21) Appl. No.: 16/833,894

(22) Filed: Mar. 30, 2020

(30) Foreign Application Priority Data
Apr. 3, 2019 (JP) 2019-071532

(51) Int. Cl. B60G 17/016; B60G 17/015

(52) U.S. Cl. CPC B60G 17/016; B60G 2400/10; B60G 2202/40; B60G 17/0152

(57) ABSTRACT

A vehicle controller includes a pendulum mechanism arranged between an under body and an upper body of a vehicle to allow an oscillation of the upper body relative to the under body, a vehicle height adjuster allowing the under body to incline, and an inclination controller controlling an operation of the vehicle height adjuster to cause the under body to incline in a direction where the upper body inclines while oscillating around a support point that is defined by the pendulum mechanism.

### CROSS REFERENCE TO RELATED APPLICATIONS

This application is based on and claims priority under 35 U.S.C. § 119 to Japanese Patent Application 2019-071532, filed on Apr. 3, 2019, the entire content of which is incorporated herein by reference.

### TECHNICAL FIELD

This disclosure generally relates to a vehicle controller.

### BACKGROUND DISCUSSION

JP2004-352196A discloses a construction where a pendulum structure is disposed between an under body (chassis) and an upper body of a vehicle for allowing a swingable movement (oscillation) of the upper body relative to the under body. Specifically, the pendulum structure allows the swingable movement of the upper body caused by acceleration of the vehicle, so that a passenger of the vehicle is unlikely to feel a change of acceleration (i.e., lateral acceleration or lateral G, for example) generated at the vehicle. The passenger may feel comfortable while the vehicle is being driven accordingly.

In a case where the upper body swingably moves by the operation of the aforementioned pendulum mechanism, the upper body inclines with a lower end thereof moving outward relative to the under body. The lower end of the upper body that protrudes outward relative to the under body may provide an oppressive feeling to surrounding vehicles.

A need thus exists for a vehicle controller which is not susceptible to the drawback mentioned above.

### SUMMARY

According to an aspect of this disclosure, a vehicle controller includes a pendulum mechanism arranged between an under body and an upper body of a vehicle to allow an oscillation of the upper body relative to the under body, a vehicle height adjuster f allowing the under body to incline, and an inclination controller controlling an operation of the vehicle height adjuster to cause the under body to incline in a direction where the upper body inclines while oscillating around a support point that is defined by the pendulum mechanism.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a vehicle according to an embodiment disclosed here;

FIG. 2 is a side view of the vehicle;

FIG. 3 is a front view of the vehicle;

FIG. 4 is a perspective view of a pendulum mechanism;

FIG. 5 is a plan view of the pendulum mechanism;

FIG. 6 is a side view of the pendulum mechanism for explaining an operation thereof;

FIG. 7 is a front view of the pendulum mechanism for explaining the operation thereof;

FIG. 8 is a block diagram of a configuration of a vehicle controller;

FIG. 9A is a side view of a longitudinal oscillation actuator as viewed from a lateral side of the vehicle;

FIG. 9B is a side view of a lateral oscillation actuator as viewed from a front side of the vehicle;

FIG. 10 is a control block diagram of the vehicle controller;

FIG. 11 is a side view of vehicle height adjusters for explaining an operation thereof;

FIG. 12 is a rear view of the vehicle height adjusters for explaining the operation thereof;

FIG. 13 is a diagram illustrating the vehicle height adjusters for explaining the operation thereof;

FIG. 14 a control block diagram of an oscillation controller and an inclination controller provided at a position control ECU;

FIG. 15 is a flowchart of a processing for controlling an inclination of an under body;

FIG. 16 is a diagram explaining a relation between an inclination angle of the upper body and an inclination angle specified for the under body;

FIG. 17 is a diagram explaining a relation between the inclination angle of the upper body and the inclination angle specified for the under body according to a first modified example;

FIG. 18 is a diagram explaining a relation between an acceleration of the vehicle and the inclination angle specified for the under body according to a second modified example;

FIG. 19 is a control block diagram illustrating an oscillation control of the upper body and an inclination control of the under body according to a third modified example;

FIG. 20 is a flowchart of a processing for controlling the inclination of the under body according to the third modified example;

FIG. 21 is a control block diagram illustrating the oscillation control of the upper body according to a fourth modified example; and

FIG. 22 is a flowchart of a processing for controlling the oscillation of the upper body according to the fourth modified example.

### DETAILED DESCRIPTION

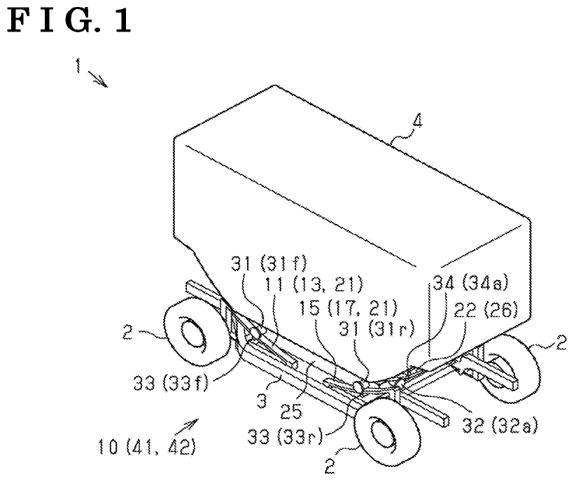

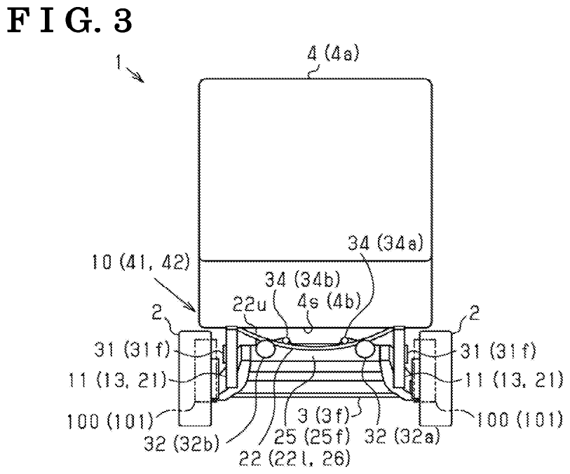

An embodiment is explained with reference to the attached drawings. As illustrated in FIGS. 1 to 3, a vehicle 1 according to the embodiment includes an under body (chassis) 3 supported by wheels 2 via respective suspensions 100 and an upper body 4 supported at an upper side of the under body 3. The vehicle 1 includes a pendulum mechanism 10 between the under body 3 and the upper body 4 for allowing a swingable movement, i.e., an oscillation, of the upper body 4 relative to the under body 3.

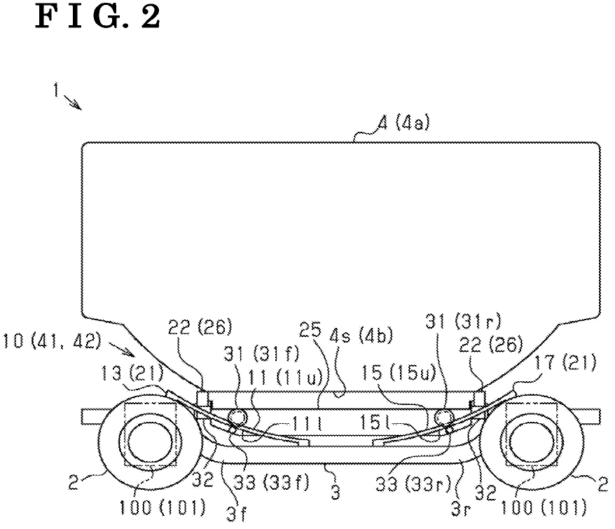

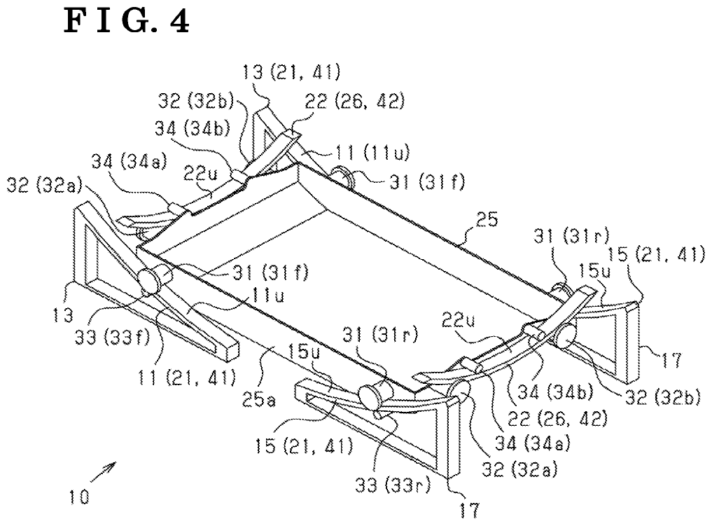

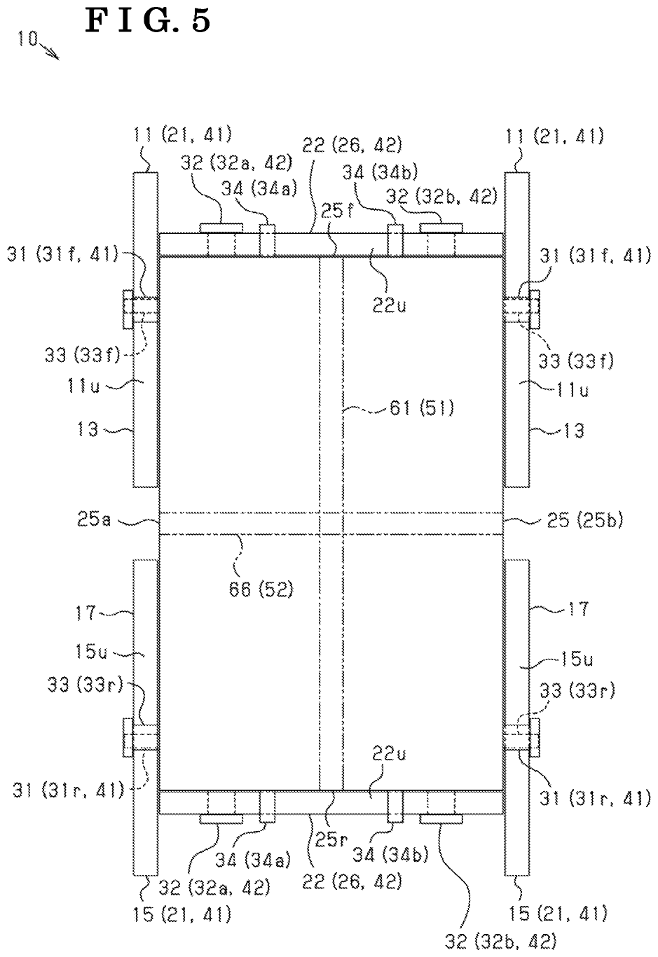

As illustrated in FIGS. 2 to 5, the pendulum mechanism 10 according to the embodiment includes a pair of front support portions 13, 13 provided at a front end portion 3f of the under body 3. The pair of front support portions 13, 13 is opposed to each other in a vehicle width direction. Specifically, each front support portion 13 includes an arc body 11 that extends from a rear side to a front side (i.e., from a right side to a left side in FIG. 2) of the vehicle 1 while curving upward. The pendulum mechanism 10 also includes a pair of rear support portions 17, 17 provided at a rear end portion 3r of the under body 3. The pair of rear support portions 17, 17 is opposed to each other in the vehicle width direction. Specifically, each rear support portion 17 includes an arc body 15 that extends from the front side to the rear side (i.e., from the left side to the right side in FIG. 2) of the vehicle 1 while curving upward. Each front support portion 13 includes a substantially triangular frame form with the arc body 11 serving as an oblique side. In the same manner, each rear support portion 17 includes a substantially triangular frame form with the arc body 15 serving as an oblique side. According to the embodiment, the pair of front support portions 13, 13 fixed to the opposed ends of the under body 3 in the vehicle width direction (i.e., right and left direction in FIG. 5) and the pair of rear support portions 17, 17 fixed to the opposed ends of the under body 3 in the vehicle width direction together constitute a pair of longitudinal oscillation support portions 21, 21 extending in a front-rear direction of the vehicle 1 and being opposed in the vehicle width direction.

The pendulum mechanism 10 includes a pair of arc bodies 22, 22 fixed to a lower surface 4s of the upper body 4 in a state being opposed to each other in the vehicle front-rear direction. The pair of arc bodies 22, 22 is respectively arranged at positions corresponding to the front end portion 3f and the rear end portion 3r of the under body 3. Each arc body 22 extending in the vehicle width direction includes a lengthwise center that protrudes downward to form a substantially arc configuration. The pair of arc bodies 22, 22 constitutes a pair of lateral oscillation support portions 26, 26 opposed to each other in the vehicle front-rear direction. The vehicle 1 according to the embodiment also includes a middle body 25 disposed between the under body 3 and the upper body 4. The pendulum mechanism 10 includes plural rollers serving as rotating bodies rotatably sliding on curving surfaces of the arc bodies 22 constituting the pair of lateral oscillation support portions 26, 26 and curving surfaces of the arc bodies 11, 15 constituting the pair of longitudinal oscillation support portions 21, 21 in a state where the rollers are fixed to the middle body 25.

That is, main rollers 31 are provided at a first side surface 25a and a second side surface 25b of the middle body 25 while projecting outward in the vehicle width direction. Specifically, the main rollers 31 include a pair of front main rollers 31f, 31f at the first side surface 25a and a pair of rear main rollers 31r, 31r at the second side surface 25b as illustrated in FIG. 5. Each main roller 31 includes a substantially shaft form. The middle body 25 is assembled on the upper side of the under body 3 in a state where the front main rollers 31f make contact, from an upper side, with the respective arc bodies 11 provided (i.e., fixed) at the under body 3 and the rear main rollers 31r make contact, from an upper side, with the respective arc bodies 15 provided (i.e., fixed) at the under body 3.

The front main rollers 31f provided at a front side (i.e., an upper side in FIG. 5) of the respective side surfaces 25a and 25b of the middle body 25 slidably make contact with upper curving surfaces 11u of the respective arc bodies 11 constituting the front support portions 13. Additionally, the rear main rollers 31r provided at a rear side (i.e., a lower side in FIG. 5) of the respective side surfaces 25a and 25b of the middle body 25 slidably make contact with upper curving surfaces 15u of the respective arc bodies 15 constituting the rear support portions 17. The upper body 4 supported above the under body 3 oscillates (i.e., swingably moves) together with the middle body 25 in the vehicle front-rear direction relative to the under body 3 in a state where the front main rollers 31f and the rear main rollers 31r roll on the upper curving surfaces 11u and 15u of the respective arc bodies 11 and 15.

Main rollers 32 are provided at a front surface 25f and a rear surface 25r of the middle body 25 while projecting in the vehicle front-rear direction. Specifically, the main rollers 32 include a pair of first-side main rollers 32a, 32a at the front surface 25f and a pair of second-side main rollers 32b, 32b at the rear surface 25r as illustrated in FIG. 5. Each main roller 32 includes a substantially shaft form. The upper body 4 is assembled on the upper side of the middle body 25 in a state where lower curving surfaces 22l of the respective arc bodies 22 fixed to the lower surface 4s of the upper body 4 make contact, from an upper side, with the main rollers 32. The upper body 4 supported above the under body 3 via the middle body 25 oscillates (i.e., swingably moves) in the vehicle width direction relative to the under body 3 in a state where the main rollers 32 provided at the front surface 25f and the rear surface 25r of the middle body 25 apparently roll on the lower curving surfaces 22l of the arc bodies 22 while slidably making contact therewith.

In the vehicle 1 according to the embodiment, auxiliary rollers 33 including a pair of front auxiliary rollers 33f, 33f and a pair of rear auxiliary rollers 33r, 33r are provided at the first side surface 25a and the second side surface 25b of the middle body 25 as illustrated in FIG. 5. Each auxiliary roller 33 includes a substantially shaft form with a smaller diameter than the diameter of each main roller 31. The pair of front auxiliary rollers 33f, 33f and the pair of rear auxiliary rollers 33r, 33r slidably make contact with lower curving surfaces 11l and 15l of the respective arc bodies 11 and 15. Additionally, auxiliary rollers 34 including a pair of first-side auxiliary rollers 34a, 34a, and a pair of second-side auxiliary rollers 34b, 34b are provided at the first side surface 25a and the second side surfaces 25b of the middle body 25 as illustrated in FIG. 5. Each auxiliary roller 34 includes a substantially shaft form with a smaller diameter than the diameter of each main roller 32. The pair of first-side auxiliary rollers 34a, 34a, and the pair of second-side auxiliary rollers 34b, 34b slidably make contact with upper curving surfaces 22u of the respective arc bodies 22. The main rollers 31 and 32 include flanges at respective ends, each flange expanding radially outward. The main rollers 31 and 32 are thus inhibited from disengaging from the arc bodies 11, 15, and 22, so that the upper body 4 supported at the upper side of the under body 3 stably oscillates (i.e., swingably moves) relative to the under body 3 accordingly.

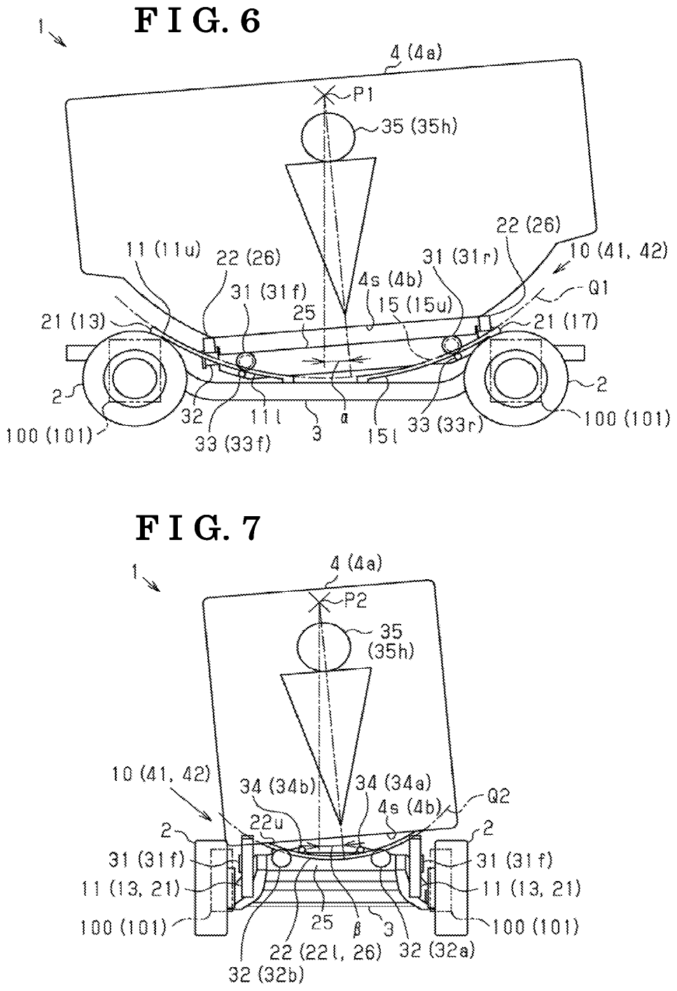

The upper body 4 of the vehicle 1 according to the embodiment includes an oscillation support point P1 in the vehicle front-rear direction. The oscillation support point P1 is defined with reference to the upper curving surfaces 11u and 15u of the arc bodies 11 and 15 constituting the longitudinal oscillation support portions 21 as illustrated in FIG. 6. Each main roller 31 (31f, 31r) slidably making contact with the upper curving surface 11u or 15u generates a rolling locus Q1 forming an arc, so that the oscillation support point P1 of the upper body 4 that is supported at the upper side of the under body 3 via the longitudinal oscillation support portions 21 and the main rollers 31 is positioned at a center (i.e., a focal point) of the aforementioned arc (the rolling locus Q1). The oscillation support point P1 is provided closer to an upper end portion 4a of the upper body 4 as illustrated in FIG. 6. A lower end portion 4b of the upper body 4 where the center of gravity (weighted center) of the vehicle 1 is located swingably moves outward in the front-rear direction of the vehicle 1, i.e., in a direction where an inertia force is generated in response to an acceleration of the vehicle 1 in the front-rear direction (an acceleration and deceleration G). That is, the vehicle 1 is constructed in a manner that the upper body 4 oscillates autonomously relative to the under body 3.

The upper body 4 of the vehicle 1 also includes an oscillation support point P2 in the vehicle width direction. The oscillation support point P2 is defined with reference to the lower curving surfaces 22l of the respective arc bodies 22 constituting the lateral oscillation support portions 26 as illustrated in FIG. 7. Each main roller 32 (32a, 32b) slidably making contact with the lower curving surface 22l generates a rolling locus Q2 forming an arc, so that the oscillation support point P2 of the upper body 4 that is supported at the upper side of the under body 3 via the lateral oscillation support portions 26 and the main rollers 32 is positioned at a center (i.e., a focal point) of the aforementioned arc (the rolling locus Q2). The oscillation support point P2 is provided closer to the upper end portion 4a of the upper body 4 as illustrated in FIG. 7. The lower end portion 4a of the upper body 4 where the center of gravity (weighted center) of the vehicle 1 is provided swingably moves outward in the vehicle width direction, i.e., in a direction where an inertia force (centrifugal force) is generated in response to an acceleration of the vehicle 1 in the width direction (a lateral acceleration G). That is, the vehicle 1 is constructed in a manner that the upper body 4 oscillates autonomously relative to the under body 3.

Each of the oscillation support portions P1 and P2 is specified at a position where a head portion 35h of a passenger 35 of the vehicle 1 is arranged in a state where the passenger 35 stands at a center of a vehicle interior formed by the upper body 4, or specified above the position of the head portion 35h. The passenger 35 is thus unlikely to feel a change of acceleration generated at the vehicle 1, which leads to comfortable driving feeling for the passenger 35.

The longitudinal oscillation support portions 21 constituted by the arc bodies 11 and 15 that are fixed to the under body 3, and the main rollers 31 serving as the rotating bodies fixed to the middle body 25 and slidably making contact with the upper curving surfaces 11u and 15u of the arc bodies 11 and 15 constitute a front-rear direction oscillation portion (which is hereinafter referred to as a longitudinal oscillation portion) 41 of the pendulum mechanism 10. Additionally, the lateral oscillation support portions 26 constituted by the arc bodies 22 that are fixed to the lower surface 4s of the upper body 4, and the main rollers 32 serving as the rotating bodies fixed to the middle body 25 and slidably making contact with the lower curving surfaces 22l of the arc bodies 22 constitute a width direction oscillation portion (which is hereinafter referred to as a lateral oscillation portion) 42 of the pendulum mechanism 10. The pendulum mechanism 10 according to the embodiment is configured to allow the upper body 4 supported at the under body 3 via the middle body 25 to oscillate in any horizontal direction relative to the under body 3 in a state where the longitudinal oscillation portion 41 and the lateral oscillation portion 42 operate in conjunction with each other.

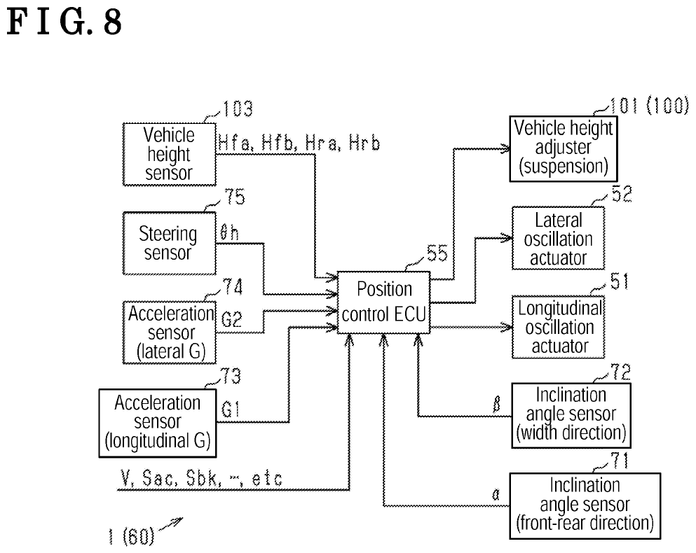

As illustrated in FIG. 8, the vehicle 1 includes a front-rear direction oscillation actuator (hereinafter referred to as a longitudinal oscillation actuator) 51 and a width direction oscillation actuator (hereinafter referred to as a lateral oscillation actuator) 52 each of which generates a driving force that changes an inclination angle (α, β) of the upper body 4 that oscillates around the support point (P1, P2) formed by the pendulum mechanism 10 (see FIGS. 6 and 7). Each operation of the longitudinal oscillation actuator 51 and the lateral oscillation actuator 52 is controlled by a position control ECU 55. With the aforementioned construction, the vehicle 1 according to the embodiment includes a vehicle controller 60 that optimizes the inclination angle (α, β) of the upper body 4 achieved by the operation of the pendulum mechanism 10, i.e., optimizes an oscillation position of the upper body 4.

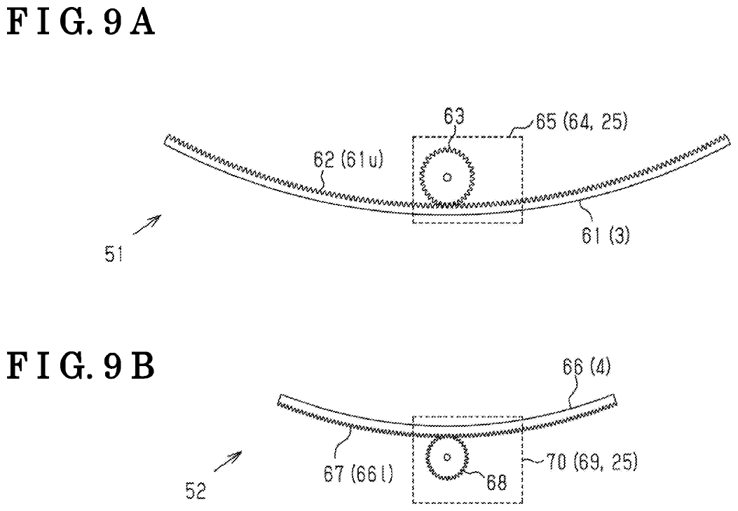

As illustrated in FIG. 9A, the longitudinal oscillation actuator 51 includes a sector gear 61 extending in the vehicle front-rear direction (i.e., right and left direction in FIG. 9A) and including a curving ratio substantially the same as that of each longitudinal oscillation support portion 21 formed by the arc body 11, 15. The sector gear 61 is fixed to the under body 3 in a state being parallel to the longitudinal oscillation support portions 21 as illustrated in FIG. 5. The longitudinal oscillation actuator 51 includes a pinion gear 63 meshed with a gear teeth portion 62 that is formed at an upper curving surface 61u of the sector gear 61. The longitudinal oscillation actuator 51 further includes a drive unit 65 that reduces rotations of a motor 64 serving as a driving source and outputs such reduced rotations. The drive unit 65 is fixed to the middle body 25 in the vehicle 1. The longitudinal oscillation actuator 51 oscillates the upper body 4 together with the middle body 25 to which the drive unit 65 is fixed, in the vehicle front-rear direction relative to the under body 3 in a state where the pinion gear 63 driven by the drive unit 65 rotates.

As illustrated in FIG. 9B, the lateral oscillation actuator 52 includes a sector gear 66 extending in the vehicle width direction (i.e., right and left direction in FIG. 9B) and including a curving ratio substantially the same as that of each arc body 22 constituting the lateral oscillation support portion 26. The sector gear 66 is fixed to the lower surface 4s of the upper body 4 in a state being parallel to the arc bodies 22 as illustrated in FIG. 5. The lateral oscillation actuator 52 includes a pinion gear 68 meshed with a gear teeth portion 67 that is formed at a lower curving surface 66l of the sector gear 66. The lateral oscillation actuator 52 further includes a drive unit 70 that reduces rotations of a motor 69 serving as a driving source and outputs such reduced rotations. The drive unit 70 is fixed to the middle body 25 in the vehicle 1. The lateral oscillation actuator 52 oscillates the upper body 4 supported at the upper side of the under body 3 via the middle body 25 in the vehicle width direction relative to the under body 3 in a state where the pinion gear 68 driven by the drive unit 70 rotates.

As illustrated in FIG. 8, the position control ECU 55 detects the inclination angle of the upper body 4 in the front-rear direction, i.e., the longitudinal inclination angle α (see FIG. 6), and the inclination angle of the upper body 4 in the width direction, i.e., the lateral inclination angle β (see FIG. 7), in response to output signals of inclination angle sensors 71 and 72 provided at the vehicle 1 when the upper body 4 oscillates relative to the under body 3. The inclination angle sensors 71 and 72 respectively detect the longitudinal inclination angle α and the lateral inclination angle β of the upper body 4 by counting pulse signals that are synchronized with the motors 64 and 49 serving as the driving sources of the longitudinal oscillation actuator 51 and the lateral oscillation actuator 52. The position control ECU 55 receives an output signal G1 from an acceleration sensor 73 that detects the acceleration of the vehicle 1 in the front-rear direction (longitudinal G) and an output signal G2 from an acceleration sensor 74 that detects the acceleration of the vehicle 1 in the width direction (lateral G). The position control ECU 55 also receives state quantities of the vehicle and control signals (i.e., vehicle information) such as a steering angle θh detected by a steering sensor 75, a vehicle speed V, an acceleration signal Sac, and a brake signal Sbk, for example. The position control ECU 55 controls the operation of the longitudinal oscillation actuator 51 and the lateral oscillation actuator 52 to optimize the oscillation position of the upper body 4 in accordance with the aforementioned vehicle information.

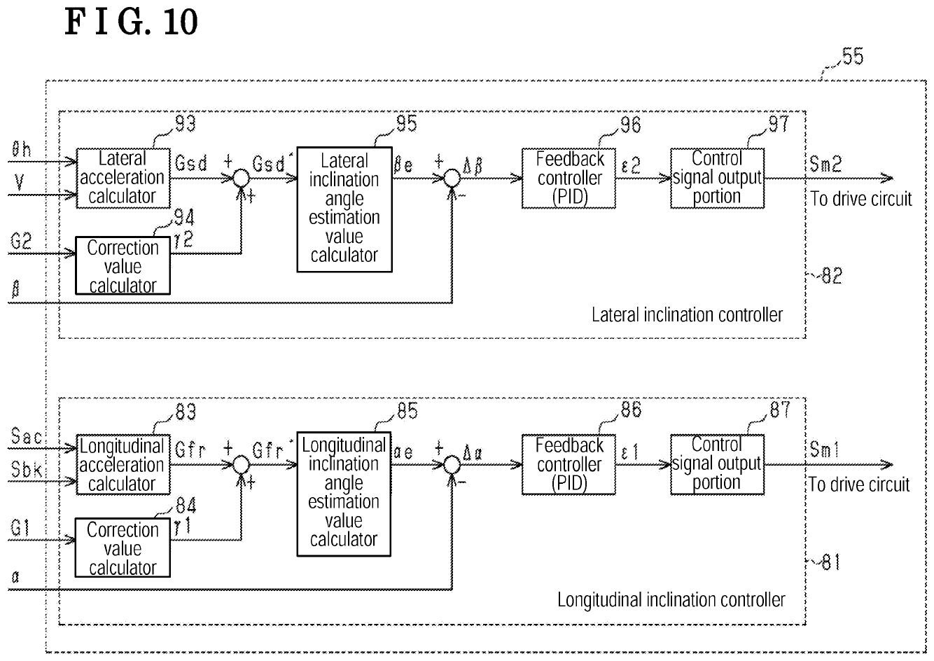

As illustrated in FIG. 10, the position control ECU 55 includes a longitudinal inclination controller 81 generating a control signal Sm1 relative to the longitudinal oscillation actuator 51 and a lateral inclination controller 82 generating a control signal Sm2 relative to the lateral oscillation actuator 52.

Specifically, the longitudinal inclination controller 81 includes a longitudinal acceleration calculator 83 calculating or estimating the acceleration of the vehicle 1 in the front-rear direction, i.e., a longitudinal acceleration Gfr, based on an accelerator position (opening) indicated in the acceleration signal Sac and a braking force of the vehicle 1 indicated in the brake signal Sbk. The longitudinal inclination controller 81 also includes a correction value calculator 84 calculating a correction value γ1 for the longitudinal acceleration Gfr that is calculated at the longitudinal acceleration calculator 83 based on the output signal G1 of the acceleration sensor 73. The longitudinal inclination controller 81 further includes a longitudinal inclination angle estimation value calculator 85 calculating an estimation value αe of the longitudinal inclination angle generated at the upper body 4 by the oscillation of the upper body 4 relative to the under body 3, based on a corrected longitudinal acceleration obtained after the correction value γ1 is added to the longitudinal acceleration Gfr, i.e., a longitudinal acceleration Gfr′.

The longitudinal inclination controller 81 includes a feedback controller 86 performing a feedback control calculation based on a difference Δα between the estimation value αe of the longitudinal inclination angle and the actual value (actual value α) of the longitudinal inclination angle of the upper body 4 detected by the inclination angle sensor 71. Specifically, the feedback controller 86 calculates a control amount ε1 of the longitudinal oscillation actuator 51 so that the actual value α follows the estimation value αe of the longitudinal inclination angle of the upper body 4. The longitudinal inclination controller 81 includes a control signal output portion 87 outputting the control signal Sm1 to a drive circuit based on the control amount ε1 calculated by the feedback controller 86.

The lateral inclination controller 82 includes a lateral acceleration calculator 93 calculating or estimating the acceleration of the vehicle 1 in the vehicle width direction, i.e., a lateral acceleration Gsd, based on the steering angle θh and the vehicle speed V. The lateral inclination controller 82 also includes a correction value calculator 94 calculating a correction value γ2 for the lateral acceleration Gsd that is calculated at the lateral acceleration calculator 93 based on an output signal G2 of the acceleration sensor 74. The lateral inclination controller 82 further includes a lateral inclination angle estimation value calculator 95 calculating an estimation value βe of the lateral inclination angle generated at the upper body 4 by the oscillation of the upper body 4 relative to the under body 3, based on a corrected lateral acceleration obtained after the correction value γ2 is added to the lateral acceleration Gsd, i.e., a lateral acceleration Gsd′.

The lateral inclination controller 82 includes a feedback controller 96 performing a feedback control calculation based on a difference Δβ between the estimation value βe of the lateral inclination angle and the actual lateral value (actual value β) of the lateral inclination angle of the upper body 4 detected by the inclination angle sensor 72. Specifically, the feedback controller 96 calculates a control amount ε2 of the lateral oscillation actuator 52 so that the actual value β follows the estimation value βe of the lateral inclination angle of the upper body 4. The lateral inclination controller 82 includes a control signal output portion 97 outputting the control signal Sm2 to a drive circuit based on the control amount ε2 calculated by the feedback controller 96.

The position control ECU55 inputs the output signals G1 and G2 of the acceleration sensors 73 and 74 into the respective correction value calculators 84 and 94 after the signals G1 and G2 pass through a low-pass filter. The inclination angle of the upper body 4 depending on the acceleration (Gfr, Gsd) is estimated, i.e., the estimation values αe and βe are calculated at the longitudinal acceleration calculator 83 and the lateral acceleration calculator 93, using a linear approximation formula (y=Ax+B) that is obtained experimentally or by simulation, for example. Each of the feedback controllers 86 and 96 performs PID (proportional-integral-derivative) control as the feedback control. The control signal output portions 87 and 97 generate and output, as the control signals Sm1 and Sm2, motor control signals for controlling the operation of the motors 64 and 69 serving as the driving sources of the respective longitudinal oscillation actuator 51 and the lateral oscillation actuator 52.

The longitudinal inclination controller 81 of the position control ECU 55 generates the control signal Sm1 that brings the actuator 51 to generate a driving force in a direction where the longitudinal inclination angle α of the upper body 4 increases in a case where the actual value α is smaller than the estimation value αe of the longitudinal inclination angle calculated on a basis of the longitudinal acceleration Gfr of the vehicle 1. In a case where the actual value α is greater than the estimation value αe, the longitudinal inclination controller 81 generates the control signal Sm1 that brings the actuator 51 to generate a driving force in a direction where the longitudinal inclination angle α of the upper body 4 decreases.

Similarly, the lateral inclination controller 82 of the position control ECU 55 generates the control signal Sm2 that brings the actuator 52 to generate a driving force in a direction where the lateral inclination angle β of the upper body 4 increases in a case where the actual value β is smaller than the estimation value βe of the lateral inclination angle calculated on a basis of the lateral acceleration Gsd of the vehicle 1. In a case where the actual value β is greater than the estimation value βe, the lateral inclination controller 82 generates the control signal Sm2 that brings the actuator 52 to generate a driving force in a direction where the lateral inclination angle β of the upper body 4 decreases. The vehicle controller 60 optimizes the oscillation position of the upper body 4 by the operation of the pendulum mechanism 10 accordingly.

Each suspension 100 of the vehicle 1 as illustrated in FIGS. 2, 3 and 8 includes a function as a vehicle height adjuster 101 adjusting the height of the vehicle 1 at each wheel 2 so that the under body 3 inclines. The position control ECU 55 controls the operation of each vehicle height adjuster 101. The vehicle controller 60 thus inclines the under body 3 in response to the oscillation (swingable movement) of the upper body 4.

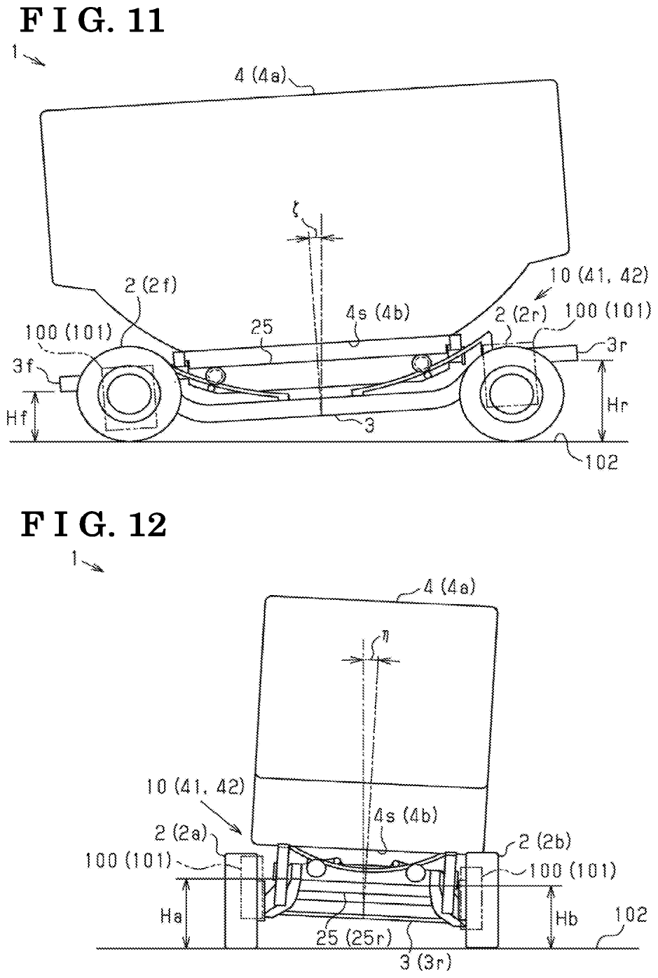

Specifically, as illustrated in FIG. 11, the vehicle height adjusters 101 change balance between a height Hf of the front end portion 3f supported by front wheels 2f and a height Hr of the rear end portion 3r supported by rear wheels 2r so as to incline the underbody 3 in the vehicle front-rear direction. Additionally, as illustrated in FIG. 12, the vehicle height adjusters 101 change balance between a height Ha and a height Hb of opposed end portions of the vehicle 1 in the vehicle width direction supported by left and right wheels 2a and 2b so as to incline the under body 3 in the vehicle width direction. The heights Hf, Hr, Ha, and Hb are defined on a basis of a reference surface, i.e., a driving road 102.

In FIG. 11, the under body 3 inclines forward (i.e., leftward in FIG. 11) in a state where the height Hr of the rear end portion 3r is greater than the height Hf of the front end portion 3f (Hf<Hr). In FIG. 12, the under body 3 inclines rightward in the vehicle width direction in a state where the height Ha on the left side is greater than the height Hb on the right side (Hb<Ha).

The position control ECU 55 controls the operation of the vehicle height adjusters 101 to incline the under body 3 in a direction where the upper body 4 inclines by the operation of the pendulum mechanism 10. The vehicle controller 60 restrains (decreases) a protruding amount of the upper body 4 that swingably moves outward by its oscillation relative to the under body 3.

Specifically, the upper body 4 supported at the upper side of the under body 3 inclines together with the under body 3, so that an oscillation support point P of the upper body 4 defined by the pendulum mechanism 10 moves to an inclined direction of the under body 3.

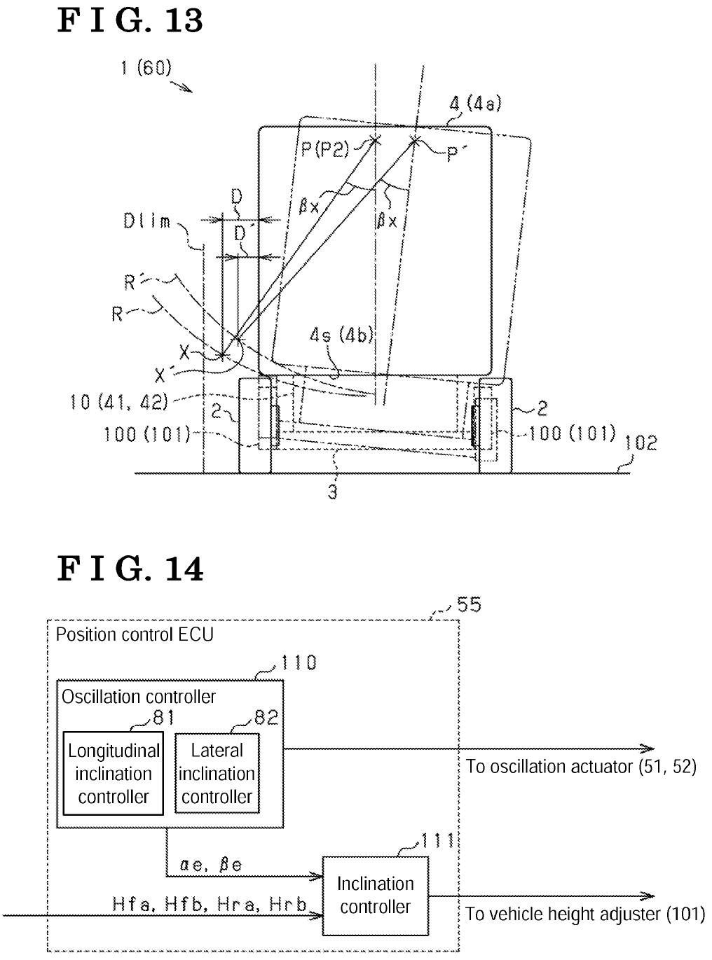

For example, as illustrated in FIG. 13, in a case where the upper body 4 inclines in the vehicle width direction by the operation of the pendulum mechanism 10, the position control ECU 55 causes the under body 3 to incline in the direction where the upper body 4 inclines (i.e., a right side in FIG. 13). The oscillation support point P (P2) located at the upper end portion 4a of the upper body 4 by the pendulum mechanism 10 moves in the inclined direction of the under body 3, i.e., in a direction opposite to a direction where the lower end portion 4b of the upper body 4 swingably moves outward in the vehicle width direction relative to the under body 3 (i.e., the oscillation support point moves from P to P′ in FIG. 13). Such shifting of the oscillation support point causes a moving locus R of the lower end portion 4b depicted by the upper body 4 that is oscillating (swingably moving) to move in the inclined direction of the under body 3 (i.e., the moving locus changes from R to R′).

Specifically, in a case where the inclination angle of the upper body 4 (lateral inclination angle β) is fixed to an angle βx, a protrusion position X′ of the upper body 4 when the under body 3 inclines in the direction where the upper body 4 inclines is closer to the under body 3 than a protrusion position X of the upper body 4 when the under body 3 does not incline. A protrusion amount D of the upper body 4 that swingably moves outward relative to the under body 3, i.e., moves leftward in FIG. 13, is restrained from increasing (the protrusion amount is changed from D to D′, D>D′).

Additionally, the position control ECU 55 controls the operation of each vehicle height adjuster 101 so that the under body 3 inclines in the direction where the upper body 4 inclines by its oscillation, in a case where the upper body 4 inclines in the vehicle front-rear direction by the operation of the pendulum mechanism 10 as illustrated in FIG. 11. The vehicle controller 60 thus restrains and decreases the protrusion amount of the upper body 4 that swingably moves outward by its oscillation in any horizontal direction of the vehicle 1 relative to the under body 3.

As illustrated in FIG. 14, the position control ECU 55 includes an oscillation controller 110 and an inclination controller 111. The oscillation controller 110 includes the longitudinal inclination controller 81 and the lateral inclination controller 82 to control the oscillation position of the upper body 4. The inclination controller 111 controls the operation of each vehicle height adjuster 101 to incline the under body 3.

Specifically, the position control ECU 55 detects heights Hfa, Hfb, Hra, and Hrb of the under body 3 at respective corners thereof where the wheels 2 are disposed, i.e., front right and left corners and rear right and left corners, in accordance with an output signal of a vehicle height sensor 103 as illustrated in FIGS. 8 and 14. The inclination controller 111 detects an inclined angle of the under body 3 in the front-rear direction (i.e., a longitudinal inclined angle ζ as illustrated in FIG. 11), and an inclined angle of the under body 3 in the vehicle width direction (i.e., a lateral inclined angle η as illustrated in FIG. 12) based on the heights Hfa, Hfb, Hra, and Hrb defined at the respective corners of the under body 3 where the wheels 2 are disposed.

As illustrated in FIG. 14, the inclination controller 111 receives the estimation values αe and βe of the longitudinal inclination angle and the lateral inclination angle calculated at the longitudinal inclination controller 81 and the lateral inclination controller 82 as inclination angles generated at the upper body 4 by its oscillation. The inclination controller 111 controls the longitudinal inclined angle ζ and the lateral inclined angle η of the under body 3 based on the aforementioned estimation values αe and βe of the longitudinal inclination angle and the lateral inclination angle of the upper body 4.

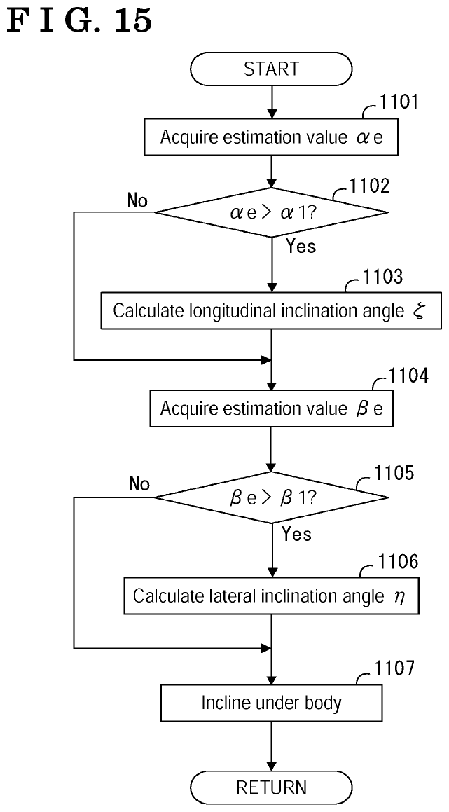

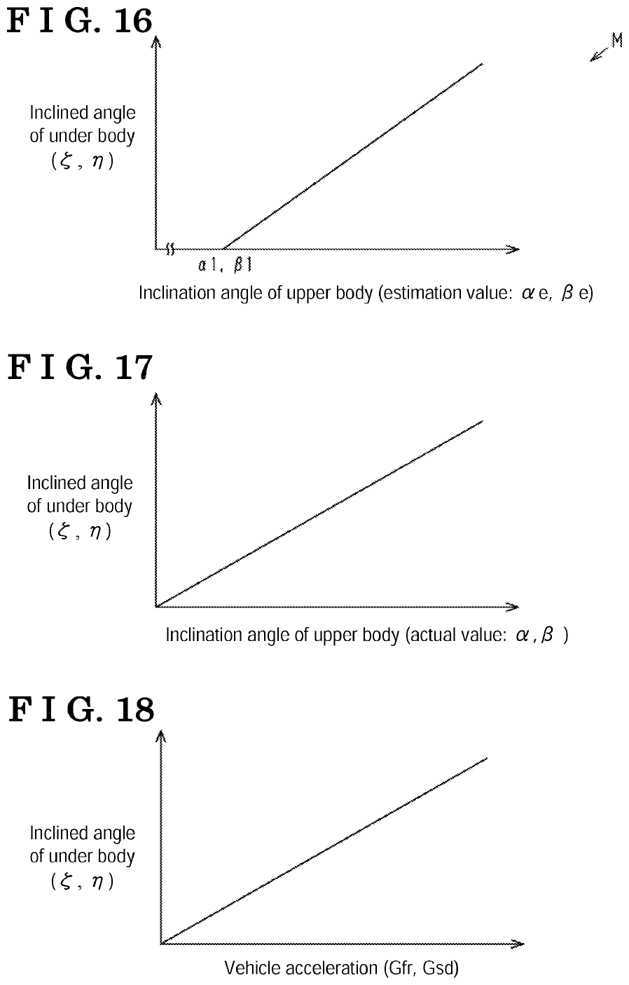

Specifically, according to a flowchart illustrated in FIG. 15, the inclination controller 111 obtains the estimation value αe of the longitudinal inclination angle as the inclination angle generated at the upper body 4 by its oscillation (step 1101). The inclination controller 111 compares the estimation value αe with a predetermined adjustment start angle α1 (step 1102). In a case where the estimation value αe is greater than the adjustment start angle α1 (αe>α1, Yes at step 1102), i.e., the upper body 4 inclines in the vehicle front-rear direction beyond the adjustment start angle α1, the inclination controller 111 calculates the longitudinal inclined angle ζ specified for the under body 3 based on the estimation value αe of the longitudinal inclination angle that exceeds the adjustment start angle α1 (step 1103).

Additionally, the inclination controller 111 obtains the estimation value βe of the lateral inclination angle as the inclination angle generated at the upper body 4 (step 1104). The inclination controller 111 compares the estimation value βe with a predetermined adjustment start angle β1 (step 1105). In a case where the estimation value βe is greater than the adjustment start angle β1 (βe>β1, Yes at step 1105), i.e., the upper body 4 inclines in the vehicle width direction beyond the adjustment start angle β1, the inclination controller 111 calculates the lateral inclined angle η specified for the under body 3 based on the estimation value βe of the lateral inclination angle that exceeds the adjustment start angle β1 (step 1106).

Specifically, as illustrated in FIG. 13, a protrusion allowable limit Dlim is specified at the vehicle 1 as a limit position of the upper body 4 where the protrusion amount D thereof from the under body 3 is allowable when the lower end portion 4b of the upper body 4 swingably moves outward relative to the under body 3 by the operation of the pendulum mechanism 10. According to the inclination controller 111, the adjustment start angles α1 and β1 are specified to values so that the protrusion amount D of the upper body 4 is inhibited from exceeding the predetermined protrusion allowable limit Dlim specified at the outside of the under body 3 in a state where the under body 3 is not inclined.

The inclination controller 111 calculates a greater value for the longitudinal inclined angle ζ specified for the under body 3 with the greater longitudinal inclination angle α of the upper body 4 based on the estimation value αe of the longitudinal inclination angle of the upper body 4 exceeding the adjustment start angle α1. Similarly, the inclination controller 111 calculates a greater value for the lateral inclined angle η specified for the under body 3 with the greater lateral inclination angle β of the upper body 4 based on the estimation value βe of the lateral inclination angle of the upper body 4 exceeding the adjustment start angle β1. The inclination controller 111 controls the operation of each vehicle height adjuster 101 so that the longitudinal inclined angle ζ and the lateral inclined angle η match the values calculated at step 1103 and step 1106 of the flowchart in FIG. 15. The inclination controller 111 thus adjusts the heights Hfa, Hfb, Hra, and Hrb of the under body 3 at positions where the wheels 2 are disposed (step 1107).

The inclination controller 111 holds and stores a relation between the estimation value αe of the longitudinal inclination angle of the upper body 4 and the longitudinal inclined angle ζ specified for the under body 3, and a relation between the estimation value βe of the lateral inclination angle of the upper body 4 and the lateral inclined angle η specified for the under body 3 at a storage area, in a form of individual maps M. The inclination controller 111 does not perform the operation at step 1103 in a case where the estimation value αe is equal to or smaller than the adjustment start angle α1 (αe≤α1, at step 1102). Similarly, the inclination controller 111 does not perform the operation at step 1106 in a case where the estimation value βe is equal to or smaller than the adjustment start angle β1 (βe≤β1, No at step 1105). The vehicle controller 60 is configured to incline the under body 3 in the direction where the upper body 4 inclines in a case where the upper body 4 inclines beyond the adjustment start angle α1 or β1 in the vehicle front-rear direction or the vehicle width direction.

According to the embodiment, the vehicle controller 60 includes the pendulum mechanism 10 disposed between the under body 3 and the upper body 4 of the vehicle 1 to allow the oscillation of the upper body 4 relative to the under body 3. The vehicle controller 60 also includes vehicle height adjusters 101 allowing the under body 3 to incline. The vehicle controller 60 further includes the position control ECU 55 including the inclination controller 111 that controls the operation of the vehicle height adjusters 101 to cause the under body 3 to incline in the direction where the upper body 4 inclines while oscillating around the support point (the oscillation support P) formed by the pendulum mechanism 10.

Specifically, the under body 3 inclines together with the upper body 4 supported at the upper side of the under body 3 in the direction where the upper body 4 inclines, which causes the oscillation support point P of the upper body 4 defined by the pendulum mechanism 10 to move in the inclination direction of the upper body 4 (the oscillation support point moves from P to P′). Such shifting of the oscillation support point causes the moving locus R of the lower end portion 4b depicted by the oscillating upper body 4 to move in the inclined direction of the under body 3 (i.e., the moving locus moves from R to R′). The protrusion position of the upper body 4 is thus made closer to the under body 3 than the protrusion position of the upper body 4 when the under body 3 is not inclined (the protrusion position moves from X to X′). The protrusion amount D of the upper body 4 that moves outside the under body 3 by the operation of the pendulum mechanism 10 is reduced accordingly (the protrusion amount is changed from D to D′, D>D′).

The inclination controller 111 controls the under body 3 to incline in the direction where the upper body 4 inclines in a case where the inclination angle (α, β) of the upper body 4 that oscillates around the oscillation support point P by the operation of the pendulum mechanism 10 exceeds the predetermined adjustment start angle (α1, β1).

In a case where the inclination angle (α, β) of the upper body 4 is small, a change of appearance of the vehicle 1 caused by the upper body 4 swingably moving outward relative to the under body 3 is small, so that an influence on surroundings of the vehicle 1 caused by such change of appearance is also small. The protrusion amount of the upper body 4 is effectively restrained from increasing while energy consumption that may be caused by the operation of the vehicle height adjusters 101 is inhibited.

The adjustment start angle (α1, β1) is specified to a value so that the protrusion amount D of the upper body 4 is inhibited from exceeding the predetermined protrusion allowable limit Dlim specified at the outside of the under body 3 in a state where the under body 3 is not inclined. The protrusion amount D is effectively restrained from exceeding the protrusion allowable limit Dlim accordingly.

The inclination controller 111 specifies the greater inclined angle (ζ, η) for the under body 3 with the greater inclination angle (α, β) of the upper body 4 that inclines while oscillating. That is, the greater the inclination angle (α, β) of the upper body 4 is, the greater the protrusion amount D of the upper body 4 is from the under body 3. The under body 3 is appropriately inclined to reduce the protrusion amount D of the upper body 4 accordingly.

The inclination controller 111 determines whether the inclination angle (α, β) of the upper body 4 exceeds the adjustment start angle (α1, β1) and calculates the inclined angle (ζ, η) specified for the under body 3 using the estimation value (αe, βe) of the inclination angle of the upper body 4 based on the acceleration (Gfr, Gsd) of the vehicle 1.

The inclination angle (α, β) generated at the upper body 4 while the upper body 4 is oscillating is predicted, i.e., estimated beforehand, to control the operation of each vehicle height adjuster 101. The under body 3 is thus appropriately inclined without delay.

The vehicle controller 60 includes the actuators 51 and 52 each generating the driving force that allows the inclination angle (α, β) of the oscillating upper body 4 to change, and the position control ECU 55 including the oscillation controller 110 that controls the operation of the actuators 51 and 52. The oscillation controller 110 increases the inclination angle (α, β) of the upper body 4 in a case where the inclination angle, specifically, the actual value (α, β) of the inclination angle of the upper body 4, is smaller than the estimation value (αe, βe) of the inclination angle of the upper body 4 that depends on the acceleration (Gfr, Gsd) of the vehicle 1. The oscillation controller 110 decreases the inclination angle (α, β) in a case where the actual value (α, β) of the inclination angle is greater than the estimation value (αe, βe).

The inclination angle (α, β) of the upper body 4 generated by the operation of the pendulum mechanism 10, i.e., the oscillation position of the upper body 4, is optimized without influence of disturbance such as a weight shift by the passenger changing his/her position in the vehicle 1 or external factors including a side wind, for example. Even when the inclination angle (α, β) of the upper body 4 generated autonomously by its oscillation in response to the acceleration of the vehicle 1 is insufficient, the driving force of the actuator 51, 52 may cover such insufficiency, which may lead to a comfortable driving feeling.

The oscillation position of the upper body 4 is controllable with small output by a combination of the pendulum mechanism 10 that autonomously oscillates and the actuator 51, 52. The vehicle controller 60 is downsized and energy saving is achievable accordingly.

The aforementioned embodiment may be modified as explained below. The aforementioned embodiment and the following modified examples may be appropriately combined.

According to the embodiment, the acceleration of the vehicle 1 is estimated on a basis of the state quantities θh, V of the vehicle 1 and the control signals Sac, Sbk. The estimated acceleration (Gfr, Gsd) is corrected with the correction value (γ1, γ2) that is based on the output signal G1, G2 of the acceleration sensor 73, 74. The corrected acceleration (Gfr′, Gsd′) is used for calculating the estimation value (αe, βe) of the inclination angle generated at the upper body 4 while the upper body 4 is oscillating in response to the acceleration of the vehicle 1.

Alternatively, the estimation value (αe, βe) of the inclination angle may be calculated mainly with actual measured value (actual acceleration) based on the output signal (G1, G2) of the acceleration sensor 73, 74. In this case, limits may be put on variation of each estimated value (αe, βe) per calculation thereof (i.e., a guard value is set), for example. While influence of noise into the output signal G1, G2 from the acceleration sensor 73, 74 is restrained, the oscillation position of the upper body 4 is stably controllable.

The estimation value (αe, βe) of the inclination angle of the upper body 4 may be calculated only using the estimated acceleration (Gfr, Gsd). Additionally, the estimation value (αe, βe) of the inclination angle of the upper body 4 may be calculated only using the actual measured value based on the output signal G1, G2 of the acceleration sensor 73, 74. The acceleration of the vehicle 1 may be estimated using state quantities and control signals other than the steering angle θh, the vehicle speed V, the acceleration signal Sa, or the brake signal Sbk.

According to the embodiment, the inclination angle (α, β) of the upper body 4 in response to the acceleration (Gfr, Gsd) of the vehicle 1 is estimated, i.e., the estimation value (αe, βe) is calculated at the longitudinal acceleration calculator 83 or the lateral acceleration calculator 93, using a linear approximation formula (y=Ax+B) obtained experimentally or by simulation, for example. Alternatively, the estimation value (αe, βe) is calculated using a map where a relation between the acceleration (Gfr, Gsd) of the vehicle 1 and the estimation value (αe, βe) of the inclination angle is specified.

According to the embodiment, the pendulum mechanism 10 includes the longitudinal oscillation portion 41 allowing the oscillation of the upper body 4 in the vehicle front-rear direction and the lateral oscillation portion 42 allowing the oscillation of the upper body 4 in the vehicle width direction. Alternatively, the pendulum mechanism 10 may include only the longitudinal oscillation portion 41 or only the lateral oscillation portion 42.

The vehicle 1 may include a first direction oscillation portion and a second direction oscillation portion allowing the oscillation of the upper body 4 in a first direction and a second direction orthogonal to each other, instead of the longitudinal direction and the width direction of the vehicle 1. The first direction oscillation portion and the second direction oscillation portion operating in conjunction with each other may allow the upper body 4 to oscillate in any direction on a plane including the first direction and the second direction (for example, a horizontal plane). The passenger of the vehicle 1 may have a comfortable driving feeling accordingly.

According to the embodiment, the longitudinal oscillation portion 41 of the pendulum mechanism 10 is constituted by the arc bodies 11 and 15 fixed to the under body 3 and the main rollers 31 fixed to the middle body 25 and slidably making contact with the upper curving surfaces 11u and 15u of the arc bodies 11 and 15. The lateral oscillation portion 42 of the pendulum mechanism 10 is constituted by the arc bodies 22 fixed to the lower surface 4s of the upper body 4 and the main rollers 32 fixed to the middle body 25 and slidably making contact with the lower curving surfaces 22l of the arc bodies 22. Alternatively, any other construction of the pendulum mechanism 10 may be used, so that the upper body 4 oscillates autonomously in a state where the lower end portion 4b of the upper body 4 where the center of gravity of the vehicle 1 is located swingably moves in a direction where an inertia force acts. For example, the upper body 4 may be hung from a support point formed at the under body 3.

According to the embodiment, the vehicle height adjuster 101 adjusts the height of the under body 3 at each wheel 2 so as to conform to the operations of the longitudinal oscillation portion 41 and the lateral oscillation portion 42 constituting the pendulum mechanism 10. The under body 3 is thus configured to incline in the vehicle front-rear direction and the vehicle width direction. Alternatively, in a case where the pendulum mechanism 10 includes only the longitudinal oscillation portion 41, the under body 3 may incline only in the vehicle front-rear direction. In a case where the pendulum mechanism 10 includes only the lateral oscillation portion 42, the under body 3 may incline only in the vehicle width direction. That is, the under body 3 inclines in a direction where the upper body 4 is allowed to oscillate.

According to the embodiment, the under body 3 inclines when the inclination angle (α, β) generated at the upper body 4 exceeds the predetermined adjustment start angle (α1, β1). Whether the inclination angle (α, β) exceeds the predetermined adjustment start angle α1, β1 is determined on a basis of the estimation value (αe, βe) of the inclination angle that depends on the acceleration (Gfr, Gsd) of the vehicle 1. Alternatively, whether the inclination angle (α, β) exceeds the predetermined adjustment start angle (α1, β1) may be determined on a basis of the actual value (α, β) of the inclination angle of the upper body 4. In this case, the adjustment start angle (α1, β1) may be specified to be low beforehand in view of the operation speed of each vehicle height adjuster 101. The protrusion amount D of the upper body 4 is effectively restrained accordingly.

The under body 3 may incline in response to the inclination angle (α, β) of the upper body 4 as illustrated in FIG. 17 according to a first modified example, without the adjustment start angle (α1, β1) being specified. Additionally, the inclined angle (ζ, η) specified for the under body 3 may be calculated using the actual value (α, β) of the inclination angle of the upper body 4.

In FIG. 17, the greater inclined angle (ζ, η) is specified for the under body 3 with the greater inclination angle (α, β) of the upper body 4 so as to incline the under body 3. In this case, the inclined angle (ζ, η) specified for the under body 3 does not necessarily increase linearly in response to the increase of the inclination angle (α, β) of the upper body 4. For example, the fixed inclined angle (ζ, η) may be specified for the under body 3 in a case where the inclination angle (α, β) generated at the upper boy 4 exceeds the predetermined adjustment start angle (α1, β1). Additionally, the inclined angle (ζ, η) specified for the under body 3 may increase in a stepwise manner in response to the increase of the inclination angle (α, β) generated at the upper body 4, for example.

As illustrated in FIG. 18 according to a second modified example, the inclined angle (ζ, η) specified for the under body 3 may be calculated on a basis of the acceleration (Gfr, Gsd) of the vehicle 1. Specifically, the inclination angle (α, β) generated at the upper body 4 increases by the operation of the pendulum mechanism 10 with increase of the acceleration (Gfr, Gsd) of the vehicle 1. Thus, the greater inclined angle (ζ, η) may be specified for the under body 3 with the greater acceleration (Gfr, Gsd) of the vehicle 1 to appropriately incline the under body 3, which restrains the protrusion amount D of the upper body 4 from increasing.

The under body 3 may be inclined by the operation of the vehicle height adjusters 101, and the under body 3 and the upper body 4 are together inclined. Afterwards, the upper body 4 may oscillate by the operation of the pendulum mechanism 10.

Specifically, the inclined angle (ζ, η) specified for the under body 3 may be calculated on a basis of the acceleration (Gfr, Gsd) of the vehicle 1. The upper body 4 may be restricted from oscillating until the inclined angle (ζ, η) exceeds a predetermined oscillation allowable angle (ζ0, η0).

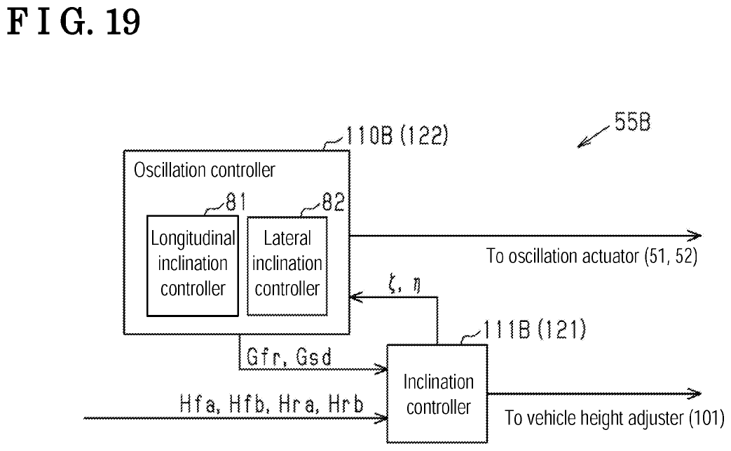

For example, a position control ECU 55B as illustrated in FIG. 19 according to a third modified example includes an inclination controller 111B that receives the longitudinal acceleration Gfr and the lateral acceleration Gsd (Gfr′ and Gsd′, see FIG. 10) of the vehicle 1 those of which are used at the longitudinal inclination controller 81 and the lateral inclination controller 82 constituting an oscillation controller 110B. The inclination controller 111B functions as an inclined angle calculator 121 (see FIG. 18) calculating the inclined angle (ζ, η) specified for the under body 3 based on the acceleration (Gfr, Gsd) of the vehicle 1.

The inclination controller 111B outputs the calculated inclined angle (ζ, η) specified for the under body 3 to the oscillation controller 110B. The oscillation controller 110B functions as an oscillation restrictor 122 restricting the oscillation of the upper body 4 until the inclined angle (ζ, η) of the under body 3 exceeds the oscillation allowable angle (ζ0, η0).

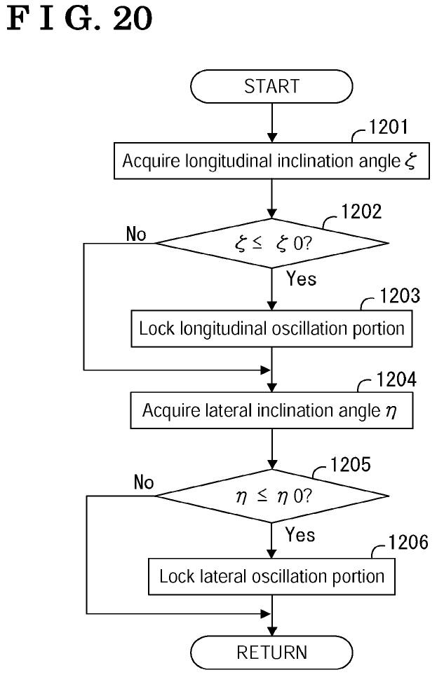

Specifically, according to a flowchart illustrated in FIG. 20, the oscillation controller 110B functioning as the oscillation restrictor 122 obtains the longitudinal inclined angle ζ of the under body 3 calculated at the inclination controller 111B serving as the inclined angle calculator 121 (step 1201). The oscillation controller 110B then compares the longitudinal inclined angle ζ with the predetermined oscillation allowable angle ζ0 (step 1202). In a case where the longitudinal inclined angle ζ is equal to or smaller than the oscillation allowable angle ζ0 (ζ≤ζ0, Yes at step 1202), the operation of the longitudinal oscillation portion 41 of the pendulum mechanism 10 is locked (i.e., the longitudinal oscillation portion 41 is prohibited from operating). The operation of the longitudinal oscillation actuator 51 is controlled to thereby restrict the oscillation of the upper body 4 in the vehicle front-rear direction (step 1203).

When acquiring the lateral inclined angle η of the under body 3 calculated at the inclination controller 111B (step 1204), the oscillation controller 110B compares the lateral inclined angle η with the predetermined oscillation allowable angle η0 (step 1205). When the lateral inclined angle η is equal to or smaller than the oscillation allowable angle η0 (η≤η0, Yes at step 1205), the operation of the lateral oscillation portion 42 of the pendulum mechanism 10 is locked (i.e., the lateral oscillation portion 42 is inhibited from operating). The operation of the lateral oscillation actuator 52 is controlled to thereby restrict the oscillation of the upper body 4 in the vehicle width direction (step 1206).

Specifically, the oscillation of the upper body 4 caused by the operation of the pendulum mechanism 10 is restricted in a case where an influence caused by the acceleration (Gfr, Gsd) of the vehicle 1 on the passenger within the vehicle interior defined by the upper body 4 can be reduced by the operation of the vehicle height adjusters 101 that cause the upper body 4 to incline together with the under body 3. The upper body 4 is inhibited from protruding to the outside of the under body 3, which reduces a change of appearance of the vehicle 1 and restrains surrounding vehicles from having an oppressive feeling.

In FIGS. 19 and 20 according to the third modified example, the inclination controller 111B calculates the inclined angle (ζ, η) specified for the under body 3 based on the acceleration (Gfr, Gsd) of the vehicle 1 used at the oscillation controller 110B. Alternatively, in the same manner as the inclination controller 111 according to the aforementioned embodiment, the inclination controller 111B may calculate the inclined angle (ζ, η) using the estimation value (αe, βe) of the inclination angle of the upper body 4 that is calculated on a basis of the acceleration (Gfr, Gsd) of the vehicle 1.

In the above, the oscillation controller 110B serving as the oscillation restrictor 122 locks (i.e., prohibits) the operation of the pendulum mechanism 10 by controlling the operation of the actuators 51 and 52. Alternatively, a lock mechanism may be provided separately from the actuators 51 and 52 for restricting the oscillation of the upper body 4 by locking (i.e., prohibiting the operation of) the pendulum mechanism 10. Further alternatively, the oscillation controller 110B and the oscillation restrictor 122 may be separately provided from each other. Locking the operation of the pendulum mechanism 10 and inclining the under body 3 when the inclination angle (α, β) of the upper body 4 exceeds the predetermined adjustment start angle (α1, β1) are selectable by switching the control mode.

The operation of each actuator 51, 52 may be controlled so that the protrusion amount D of the upper body 4 that swingably moves and protrudes to the outside of the under body 3 is inhibited from exceeding the protrusion allowable limit Dlim specified at the outside of the under body 3. The protrusion amount of the upper body 4 may be effectively reduced accordingly.

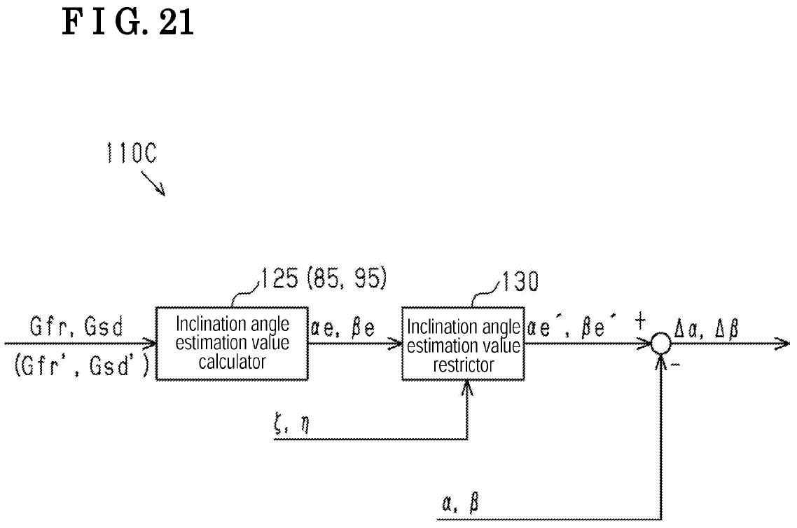

For example, an oscillation controller 110C illustrated in FIG. 21 according to a fourth modified example includes an inclination angle estimation value calculator 125 (85, 95) calculating the estimation value (αe, βe) of the inclination angle generated at the upper body 4 by the operation of the pendulum mechanism 10, and an inclination angle estimation value restrictor 130 restricting (correcting) the estimation value (αe, βe) of the inclination angle of the upper body 4 (i.e., the inclination angle estimation value restrictor 130 performs a restriction processing).

Specifically, the inclination angle estimation value restrictor 130 of the oscillation controller 110C receives the inclined angle (ζ, η) specified for the under body 3 from the inclination controller 111 (111B) (see FIG. 19) together with the estimation value (αe, βe) of the inclination angle of the upper body 4 calculated at the inclination angle estimation value calculator 125. The inclination angle estimation value restrictor 130 calculates the protrusion amount D of the upper body 4 that swingably moves and protrudes to the outside of the under body 3 based on the estimation value (αe, βe) of the inclination angle generated at the upper body 4 and the inclined angle (ζ, η) specified for the under body 3. The inclination angle estimation value restrictor 130 then restricts the estimation value (αe, βe) of the inclination angle of the upper body 4 serving as a control target value of each actuator 51, 52 so that the protrusion amount D is inhibited from exceeding the protrusion allowable limit Dlim specified at the outside of the under body 3. That is, the inclination angle estimation value restrictor 130 performs the restriction processing.

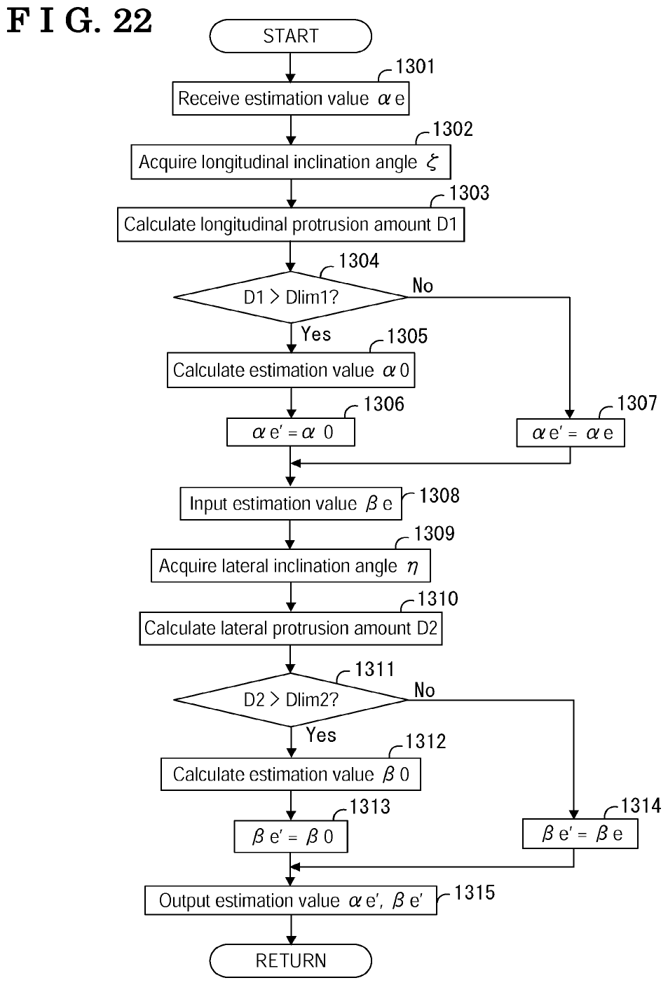

Specifically, according to a flowchart illustrated in FIG. 22, the inclination angle estimation value restrictor 130 receives the estimation value αe of the longitudinal inclination angle generated at the upper body 4 (step 1301). The inclination angle estimation value restrictor 130 first acquires the longitudinal inclined angle ζ of the under body 3 (step 1302). The inclination angle estimation value restrictor 130 then calculates a protrusion amount of the upper body 4 that swingably moves and protrudes to the outside of the under body 3 in the vehicle front-rear direction, i.e., a longitudinal protrusion amount D1, based on the estimation value αe of the longitudinal inclination angle generated at the upper body 4 and the longitudinal inclined angle ζ of the under body 3 (step 1303).

Next, the inclination angle estimation value restrictor 130 compares the longitudinal protrusion amount D1 with a protrusion allowable limit in the vehicle front-rear direction, i.e., a longitudinal protrusion allowable limit Dlim1 (step 1304). When the longitudinal protrusion amount D1 exceeds the longitudinal protrusion allowable limit Dlim1 (D1>Dlim1, Yes at step 1304), the inclination angle estimation value restrictor 130 calculates a maximum inclination angle estimation value α0 with which the longitudinal protrusion amount D1 does not exceed the protrusion allowable limit Dlim1 under the condition where the acquired longitudinal inclined angle ζ is unchanged (step 1305). The inclination angle estimation value restrictor 130 determines the maximum inclination angle estimation value α0 calculated at step 1305 to be an estimation value αe′ of the longitudinal inclination angle after the restriction processing is performed by the inclination angle estimation value restrictor 130 (αe′=α0, step 1306).

In a case where the longitudinal protrusion amount D1 is determined to be equal to or smaller than the protrusion allowable limit Dlim1 (D1≤Dlim1, No at step 1304), the inclination angle estimation value restrictor 130 does not perform the operations at steps 1305 and 1306. The inclination angle estimation value restrictor 130 determines the estimation value αe of the longitudinal inclination angle input at step 1301 directly to be the estimation value αe′ of the longitudinal inclination angle after the restriction processing is performed by the inclination angle estimation value restrictor 130 (αe′=αe, step 1307).

Additionally, the inclination angle estimation value restrictor 130 receives the estimation value βe of the lateral inclination angle generated at the upper body 4 (step 1308). The inclination angle estimation value restrictor 130 first acquires the lateral inclined angle η of the under body (step 1309). The inclination angle estimation value restrictor 130 then calculates a protrusion amount of the upper body 4 that swingably moves and protrudes to the outside of the under body 3 in the vehicle width direction, i.e., a lateral protrusion amount D2, based on the estimation value βe of the lateral inclination angle generated at the upper body 4 and the lateral inclined angle η of the under body 3 (step 1310).

Next, the inclination angle estimation value restrictor 130 compares the lateral protrusion amount D2 with a protrusion allowable limit in the vehicle width direction, i.e., a lateral protrusion allowable limit Dlim2 (step 1311). When the lateral protrusion amount D2 exceeds the lateral protrusion allowable limit Dlim2 (D2>Dlim2, Yes at step 1311), the inclination angle estimation value restrictor 130 calculates a maximum inclination angle estimation value β0 with which the lateral protrusion amount D2 does not exceed the protrusion allowable limit Dlim2 under the condition where the acquired lateral inclined angle η is unchanged (step 1312). The inclination angle estimation value restrictor 130 determines the maximum inclination angle estimation value β0 calculated at step 1312 to be an estimation value βe′ of the lateral inclination angle after the restriction processing is performed by the inclination angle estimation value restrictor 130 (βe′=β0, step 1313).

In a case where the lateral protrusion amount D2 is determined to be equal to or smaller than the protrusion allowable limit Dlim2 (D2≤Dlim2, No at step 1311), the inclination angle estimation value restrictor 130 does not perform the operations at steps 1312 and 1313. The inclination angle estimation value restrictor 130 determines the estimation value βe of the lateral inclination angle input at step 1308 directly to be the estimation value βe′ of the lateral inclination angle after the restriction processing is performed by the inclination angle estimation value restrictor 130 (βe′=βe, step 1314).

The inclination angle estimation value restrictor 130 then outputs the estimation value αe′ of the longitudinal inclination angle determined at step 1306 or 1307, and the estimation value βe′ of the lateral inclination angle determined at step 1313 or 1314 (step 1315).

The estimation value (αe, βe) of the inclination angle of the upper body 4 serving as a control target value of each actuator 51, 52 may decrease on a basis of the inclination amount of the upper body 4 that inclines together with the under body 3 by the operation of the vehicle height adjusters 101, i.e., decrease on a basis of the inclined angle (ζ, η) specified for the under body 3.

The aforementioned decrease of the estimation value (αe, βe) of the inclination angle of the upper body 4 may be achieved by a decrease controller provided at the position (see FIG. 21) of the inclination angle estimation value restrictor 130 of the oscillation controller 110C. Such decrease controller may decrease the estimation value (αe, βe) of the inclination angle in accordance with the inclined angle (ζ, η) specified for the under body 3. Then, in a construction where the estimation value (αe, βe) of the inclination angle is calculated using a map where a relation between the acceleration (Gfr, Gsd) of the vehicle 1 and the estimation value (αe, βe) of the inclination angle is defined, the decrease amount of the estimation value (αe, βe) of the inclination angle in accordance with the inclined angle (ζ, η) specified for the under body 3 may be specified beforehand in the map.

According to the embodiment including the modified examples, the vehicle controller 60 includes the actuators 51 and 52 each generating the driving force for changing the inclination angle (α, β) of the upper body 4 that oscillates by the operation of the pendulum mechanism 10. Alternatively, without the actuators 51 and 52 being provided, the under body 3 may be simply inclined in the direction where the upper body 4 inclines in a construction where the upper body 4 autonomously oscillates by the operation of the pendulum mechanism 10.

According to the vehicle controller 60 of the embodiment, the adjustment start angle is specified to a value so that the protrusion amount D of the upper body 4 is inhibited from exceeding the predetermined protrusion allowable limit Dlim specified at the outside of the under body 3 in a state where the under body 3 is not inclined. The upper body 4 is thus effectively inhibited from protruding beyond the protrusion allowable limit Dlim

Additionally, the inclination controller 111 determines whether the estimation value of the inclination angle of the upper body 4 based on the acceleration of the vehicle 1 exceeds the adjustment start angle. The inclination controller 111 calculates the inclined angle of the under body 3 using the estimation value of the inclination angle of the upper body 4 based on the acceleration of the vehicle 1.

According to the embodiment including the modified examples thereof, the inclination angle generated at the upper body 4 that is oscillating is predicted, i.e., estimated beforehand, to control the operation of the vehicle height adjusters 101. The under body 3 is thus appropriately and promptly inclined.

According to the embodiment including the modified examples thereof, a vehicle controller 60 includes a pendulum mechanism 10 arranged between an under body 3 and an upper body 4 of a vehicle 1 to allow an oscillation of the upper body 4 relative to the under body 3, a vehicle height adjuster 101 allowing the under body 3 to incline, and an inclination controller 111, 111B controlling an operation of the vehicle height adjuster 101 to cause the under body 3 to incline in a direction where the upper body 4 inclines while oscillating around a support point P that is defined by the pendulum mechanism 10.

In addition, the inclination controller 111, 111B controls the under body 3 to incline in a case where an inclination angle of the upper body 4 that inclines around the support point P while oscillating exceeds an adjustment start angle.

Further, the inclination controller 111, 111B increases an inclined angle specified for the under body 3 with an increase of the inclination angle of the upper body 4 that inclines around the support point P while oscillating.

The greater the inclination angle of the upper body 4 is, the greater the protrusion amount of the upper body 4 is from the under body 3. The under body 3 is appropriately inclined to restrain the protrusion amount of the upper body 4 from increasing from the under body 3.

According to the third modified example of the embodiment, the vehicle controller 60 further includes an inclined angle calculator 121 calculating the inclined angle specified for the under body 3 based on an acceleration of the vehicle 1. The inclined angle calculator 121 increases the inclined angle specified for the under body 3 with an increase of the acceleration of the vehicle 1.

The greater the acceleration of the vehicle 1 is, the greater the inclination angle of the upper body 4 is by the operation of the pendulum mechanism 10. The under body 3 is appropriately inclined to restrain the protrusion amount of the upper body 4 from increasing from the under body 3.

According to the third modified example of the embodiment, the vehicle controller 60 further includes an oscillation restrictor 122 restricting the oscillation of the upper body 4 until the inclined angle specified for the under body 3 exceeds an oscillation allowable angle.

According to the embodiment including the modified examples thereof, the vehicle controller 60 further includes an actuator 51, 52 generating a driving force that allows the inclination angle of the upper body 4 to change, and an oscillation controller 110, 110B, 110C controlling an operation of the actuator 51, 52 to increase the inclination angle of the upper body 4 in a case where an actual value of the inclination angle of the upper body 4 is smaller than an estimation value of the inclination angle of the upper body 4 in accordance with the acceleration of the vehicle 1, and to decrease the inclination angle of the upper body 4 in a case where the actual value is greater than the estimation value.

According to the fourth modified example of the embodiment, the oscillation controller 110C controls the operation of the actuator 51, 52 to inhibit a protrusion amount of the upper body 4 swingably moving to an outside of the under body 3 by an operation of the pendulum mechanism 10 from exceeding a protrusion allowable limit specified at the outside of the under body 3.

According to the embodiment including the modified examples thereof, the pendulum mechanism 10 includes a lateral oscillation portion 42 that allows the oscillation of the upper body 4 in a width direction of the vehicle 1.

The vehicle 1 when turning generates an acceleration in the width direction thereof. According to the embodiment, the upper body 4 autonomously oscillates in a state where the lower end portion 4a of the upper body 4 where the center of gravity of the vehicle 1 is located swingably moves in a direction in which an inertia force (centrifugal force) acts in response to the aforementioned acceleration of the vehicle 1 in the width direction. The passenger of the vehicle 1 may feel comfortable while the vehicle 1 is being driven accordingly.

In addition, the pendulum mechanism 10 includes a longitudinal oscillation portion 41 that allows the oscillation of the upper body 4 in a front-rear direction of the vehicle 1.

The vehicle 1 generates an acceleration in the front-rear direction resulting from acceleration and deceleration. According to the embodiment, the upper body 4 autonomously oscillates in a state where the lower end portion 4a of the upper body 4 where the center of gravity of the vehicle 1 is located swingably moves in a direction in which an inertia force acts in response to the aforementioned acceleration of the vehicle in the front-rear direction. The passenger of the vehicle 1 may have a comfortable driving feeling accordingly.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle controller comprising:
a pendulum mechanism arranged between an under body and an upper body of a vehicle to allow an oscillation of the upper body relative to the under body;
a vehicle height adjuster allowing the under body to incline; and
an inclination controller controlling an operation of the vehicle height adjuster to cause the under body to incline in a direction where the upper body inclines while oscillating around a support point that is defined by the pendulum mechanism.

2. The vehicle controller according to claim 1, wherein the inclination controller controls the under body to incline in a case where an inclination angle of the upper body that inclines around the support point while oscillating exceeds an adjustment start angle.

3. The vehicle controller according to claim 1, wherein the inclination controller increases an inclined angle specified for the under body with an increase of the inclination angle of the upper body that inclines around the support point while oscillating.

4. The vehicle controller according to claim 2, wherein the inclination controller increases an inclined angle specified for the under body with an increase of the inclination angle of the upper body that inclines around the support point while oscillating.

5. The vehicle controller according to claim 1, further comprising an inclined angle calculator calculating the inclined angle specified for the under body based on an acceleration of the vehicle, wherein the inclined angle calculator increases the inclined angle specified for the under body with an increase of the acceleration of the vehicle.

6. The vehicle controller according to claim 2, further comprising an inclined angle calculator calculating the inclined angle specified for the under body based on an acceleration of the vehicle, wherein the inclined angle calculator increases the inclined angle specified for the under body with an increase of the acceleration of the vehicle.

7. The vehicle controller according to claim 3, further comprising an inclined angle calculator calculating the inclined angle specified for the under body based on an acceleration of the vehicle, wherein the inclined angle calculator increases the inclined angle specified for the under body with an increase of the acceleration of the vehicle.

8. The vehicle controller according to claim 4, further comprising an oscillation restrictor restricting the oscillation of the upper body until the inclined angle specified for the under body exceeds an oscillation allowable angle.

9. The vehicle controller according to claim 5, further comprising an oscillation restrictor restricting the oscillation of the upper body until the inclined angle specified for the under body exceeds an oscillation allowable angle.

10. The vehicle controller according to claim 6, further comprising an oscillation restrictor restricting the oscillation of the upper body until the inclined angle specified for the under body exceeds an oscillation allowable angle.

11. The vehicle controller according to claim 1, further comprising:
an actuator generating a driving force that allows the inclination angle of the upper body to change; and
an oscillation controller controlling an operation of the actuator to increase the inclination angle of the upper body in a case where an actual value of the inclination angle of the upper body is smaller than an estimation value of the inclination angle of the upper body in accordance with the acceleration of the vehicle, and to decrease the inclination angle of the upper body in a case where the actual value is greater than the estimation value.

12. The vehicle controller according to claim 2, further comprising:
an actuator generating a driving force that allows the inclination angle of the upper body to change; and
an oscillation controller controlling an operation of the actuator to increase the inclination angle of the upper body in a case where an actual value of the inclination angle of the upper body is smaller than an estimation value of the inclination angle of the upper body in accordance with the acceleration of the vehicle, and to decrease the inclination angle of the upper body in a case where the actual value is greater than the estimation value.

13. The vehicle controller according to claim 3, further comprising:
an actuator generating a driving force that allows the inclination angle of the upper body to change; and
an oscillation controller controlling an operation of the actuator to increase the inclination angle of the upper body in a case where an actual value of the inclination angle of the upper body is smaller than an estimation value of the inclination angle of the upper body in accordance with the acceleration of the vehicle, and to decrease the inclination angle of the upper body in a case where the actual value is greater than the estimation value.

14. The vehicle controller according to claim 11, wherein the oscillation controller controls the operation of the actuator to inhibit a protrusion amount of the upper body swingably moving to an outside of the under body by an operation of the pendulum mechanism from exceeding a protrusion allowable limit specified at the outside of the under body.

15. The vehicle controller according to claim 12, wherein the oscillation controller controls the operation of the actuator to inhibit a protrusion amount of the upper body swingably moving to an outside of the under body by an operation of the pendulum mechanism from exceeding a protrusion allowable limit specified at the outside of the under body.

16. The vehicle controller according to claim 13, wherein the oscillation controller controls the operation of the actuator to inhibit a protrusion amount of the upper body swingably moving to an outside of the under body by an operation of the pendulum mechanism from exceeding a protrusion allowable limit specified at the outside of the under body.

17. The vehicle controller according to claim 1, wherein the pendulum mechanism includes a lateral oscillation portion that allows the oscillation of the upper body in a width direction of the vehicle.

18. The vehicle controller according to claim 2, wherein the pendulum mechanism includes a lateral oscillation portion that allows the oscillation of the upper body in a width direction of the vehicle.

19. The vehicle controller according to claim 1, wherein the pendulum mechanism includes a longitudinal oscillation portion that allows the oscillation of the upper body in a front-rear direction of the vehicle.

20. The vehicle controller according to claim 17, wherein the pendulum mechanism includes a longitudinal oscillation portion that allows the oscillation of the upper body in a front-rear direction of the vehicle.
